(19) United States
(12) Patent Application Publication
(10) Pub. No.: US 2013/0176626 A1
(43) Pub. Date: Jul. 11, 2013

(54) WEARABLE DEVICE ASSEMBLY WITH INPUT AND OUTPUT STRUCTURES

(71) Applicants: Mitchell Joseph Heinrich, San Francisco, CA (US); Maj Isabelle Olsson, San Francisco, CA (US)

(72) Inventors: Mitchell Joseph Heinrich, San Francisco, CA (US); Maj Isabelle Olsson, San Francisco, CA (US)

(73) Assignee: GOOGLE INC., Mountain View, CA (US)

(21) Appl. No.: 13/344,063

(22) Filed: Jan. 5, 2012

(51) Int. Cl. G02B 27/01

(52) U.S. Cl. 359/630

(57) ABSTRACT

An electronic device for use with a wearable structure configured to be worn on the head of a user includes a display element and a housing having an arm portion and an elbow portion. The housing is configured to be removably affixed to the wearable structure at the arm portion thereof. The elbow portion of the housing defines a display end of the housing that supports the display element. The arm extends along a longitudinal axis of the housing, and the elbow portion is configured such that the display end supports the display element along a display axis disposed at an angle with respect to the longitudinal axis. Image generating means are disposed within the housing and configured for generating an image presentable to the user on the display element. An input device is affixed to the housing and is configured for receiving from the user an input.

### BACKGROUND

Personal video or image displays are devices that are used to display an image received from a source for viewing by a single user. Such devices can be in the form of head-mounted displays that are worn on the head of a user and include one or more image sources over or in front of the user's eyes. Head-mounted displays can include an image source positioned adjacent and associated with each eye of the user or wearer and can be configured to present the same image, viewable as a single two-dimensional image. Alternatively, some such devices can be configured to present different stereoscopic images that are interpreted by the viewer as a single three-dimensional image. Regardless of the type of image presented to the user, such devices are usually blacked-out. That is, they almost entirely obstruct the wearer's vision outside of the screen or other image source included therein so that the user can see nothing but the image presented by the device's display system.

Other personal image displays can be what is referred to as a heads-up display, wherein the image is displayed on, in, or through a transparent display that superimpose the displayed image over a view of the surrounding environment. These allow the user to view the image presented by the display simultaneously with their surroundings. Such devices, however, can have many limitations, including in their fit and comfort to their wearers as well as limited functionality.

Both head-mounted and heads-up displays can be connected to a video source that receives a video signal that the device can read and convert into the image that they present to the user. The video source can be received from a portable device such as a video player, a portable media player or computers. Some such display devices are also configured to receive sound signals, which are delivered to the user typically through incorporated headphones. The functionality of these types of displays is, however, limited to passive actions wherein the display simply receives information from an external source and presents it to the wearer in limited forms. Accordingly, further advances in wearable devices including displays have been needed.

### BRIEF SUMMARY

An aspect of the present disclosure relates to an electronic device for use with a wearable structure configured to be worn on the head of a user. The device includes a display element and a housing having an arm portion and an elbow portion. The housing is configured to be removably affixed to the wearable structure at the arm portion thereof. The elbow portion of the housing defines a display end of the housing that supports the display element. The arm extends along a longitudinal axis of the housing, and the elbow portion is configured such that the display end supports the display element along a display axis disposed at an angle with respect to the longitudinal axis. The device further includes image generating means disposed within the housing and configured for generating an image presentable to the user on the display element. An input device is affixed to the housing and is configured for receiving from the user an input associated with a function that is related to information that is presentable on the display element. The display element can be a generally transparent prism configured to combine the image presentable to the user thereon with a user view through the display element.

The display axis can be angled at between about 80° and 110° with respect to the longitudinal axis. The elbow portion can be curved so as to extend away from the arm portion in an arcuate fashion to the display end of the housing. In an embodiment, the arm portion has a first thickness and the display element has a second thickness greater than the first thickness, and the elbow portion tapers from the first thickness at a location adjacent the arm portion to a second thickness at the display end thereof. The input device can be positioned in the arm portion, and the image generating means can be positioned in the elbow portion.

The housing can be configured to be removably affixed to the wearable structure such that the display element is positionable over an eye of the user. In an example, the housing can include a first snap fit element that is configured to releasably engage with a second snap fit element included on the wearable structure. The housing in such an example can be configured to be removably affixed to the wearable structure by the releasable engagement between the first and second snap fit elements. In another example the housing can include a first track element that is configured to slideably and releasably engage with a second track element included on the wearable structure. In such an example, the housing can be configured to be removably affixed to the wearable structure by the releasable engagement between the first and second track elements. Further, the slidable engagement between the first and second track elements can be configured to allow adjustment of the display element toward and away from an eye of the user. In another example, the device can further include a first electronic element coupling attached to the housing and in electrical communication with at least the image generating means. Such a first electronic element coupling can be configured to releaseably engage with a corresponding second electronic element coupling included on the wearable structure, and the housing can be configured to be removably affixed to the wearable structure by the releasable engagement between the first and second electronic element couplings. In an example, the first electronic element coupling is a universal serial bus coupling. The first electronic element coupling can be configured to provide for connection between the image generating means and an electronic element of the wearable structure.

The electronic device can further include a camera having a lens thereof. The camera can be attached to the housing such that the lens thereof is exposed on the housing within the elbow portion and is directed substantially parallel to the longitudinal axis.

In an embodiment, the arm portion and the elbow portion can be discrete elements rotatably affixed to each other about an axis substantially parallel to the display axis.

Another embodiment of the present disclosure relates to an electronic device including a module and a wearable structure. The module includes a display element and a housing. The housing includes an arm portion extending along a longitudinal axis of the housing and an elbow portion defining a display end of the housing that supports the display element along a display axis disposed at an angle to the longitudinal axis. Image generating means are disposed within the housing and are configured for generating an image presentable to a user on the display element. An input device is affixed to the housing and is configured for receiving from the user an input associated with a function that is presentable on the display element. The wearable structure is configured to be worn on the head of a user, and is configured to removeably attach with the module at a location along the arm thereof to secure the same to the head of the user with the display element positionable near an eye of the user and the arm portion disposed over a temple of the user.

In an embodiment, the wearable structure can be a band configured to be worn on the head of a user. Such a band can include an arcuate central portion and a first side portion extending from the central portion, the central portion being configured to contact a portion of the face of a user and the first side portion being configured to contact a portion of the head of the user near an ear thereof. Further, the module can be removably attached with the wearable structure on one of the side portions of the band.

The band can further include a second side portion extending from the central portion opposite the first side portion. In this example, the second side portion can be configured to contact a portion of the head of the user near another ear thereof. As an alternative, the central portion of the band can further include a nosepiece depending therefrom. In such an example, the portion of the face of the user that the central portion is configured to contact can be a portion of the nose of the user, and the nosepiece can be configured to make such contact.

In another embodiment, the wearable structure can include first and second rims with lenses affixed therein and a bridge portion positioned between the first and second rims. The bridge portion can be configured to rest on a portion of the nose of the user, and the frame can further include first and second arms extending away from the rims to respective ends thereof. The first and second arms can be configured to be positioned over respective first and second temples of the user with the free ends disposed near first and second ears of the user. In such an embodiment, the module can be removably attached with the wearable structure on one of the first and second arms.

The wearable structure can include at least one electronic element that is configured to removably connect with at least one of the image generating means and the input device. In an example, the electronic element can include a printed circuit board configured for exchanging data with the at least one of the image generating means and the input device. Additionally or alternatively, the electronic element can include conductive connections configured for connecting with a battery, and the conductive connections can be further configured to provide current from the battery to the at least one of the image generating means and the input device. Such conductive connections can be disposed within a housing configured to receive a battery therein. Such a housing can be attached to the wearable structure and configured to be positioned at least partially behind an ear of the user on a same side of the head of the user as the temple over which the arm portion of the module is disposed. The module can be removably attached with the wearable structure by releasable connection between a first connection element on the module and a second connection element on the wearable structure. The first and second connection elements can accordingly be configured for releasable engagement therebetween, and the electronic element can be configured to removably connect with the at least one of the image generating means and the input device though the first and second connection elements.

Another aspect of the present disclosure relates to a kit including a module and a first wearable structure. The module includes a display element and a housing. The housing includes an arm portion extending along a longitudinal axis of the housing and an elbow portion defining a display end of the housing that supports the display element along a display axis disposed at an angle to the longitudinal axis. Image generating means are disposed within the housing and are configured for generating an image presentable to a user on the display element. An input device is affixed to the housing and is configured for receiving from the user an input associated with a function that is presentable on the display element. The first wearable structure is configured to be worn on the head of a user. The wearable structure and the module are configured for releasable engagement therebetween such that the module can be secured to the head of the user by the wearable structure with the display element positionable near an eye of the user and the arm portion positionable over a temple of the user. The kit can further include a second wearable structure configured to be worn on the head of the user. The second wearable structure can have a different visual appearance from the first wearable structure.

### BRIEF DESCRIPTION OF THE DRAWINGS

FIG. 1 shows an exemplary system for receiving, transmitting, and displaying data;

FIG. 2 shows an alternate view of the system of FIG. 1;

FIG. 3A shows an example system for receiving, transmitting, and displaying data;

FIG. 3B shows an example system for receiving, transmitting, and displaying data;

FIG. 4 shows an example system for receiving, transmitting, and displaying data;

FIG. 5 shows a wearable computer device according to an embodiment of the present disclosure;

FIG. 6 shows a wearable structure that can be used with the device of FIG. 5;

FIG. 7 shows an assembly of a wearable computer device with a wearable structure;

FIG. 8 shows the assembly of FIG. 7 being worn on the head of a user;

FIG. 9 shows detail of an example attachment between a wearable computer device and a wearable structure;

FIG. 10A shows another embodiment of a wearable computer device;

FIGS. 10B and 10C show the device of FIG. 10A in exemplary configurations thereof;

FIGS. 11A and 11B are schematic drawings illustrating aspects of the device of FIGS. 10A-C;

FIG. 12 shows another embodiment of an assembly of a wearable computer device and a wearable structure;

FIG. 13 shows another embodiment of an assembly of a wearable computer device and a wearable structure;

FIG. 14 shows another embodiment of a wearable computer device;

FIG. 15 shows a variation of the wearable computer device shown in FIG. 14; and

FIG. 16 shows a further variation of the wearable computer device shown in FIG. 14.

### DETAILED DESCRIPTION

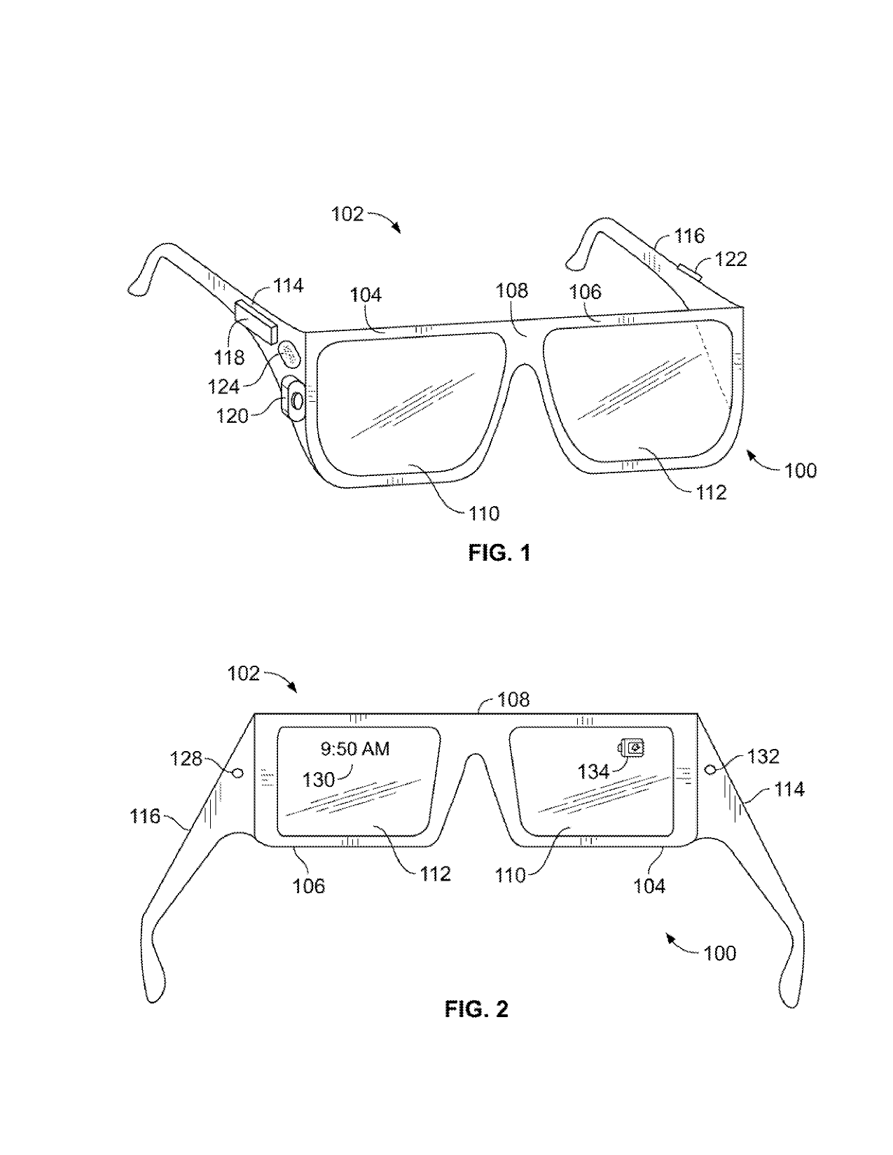

Embodiments of the present disclosure are described herein with reference to the drawing figures. FIG. 1 illustrates an example system 100 for receiving, transmitting, and displaying data. The system 100 is shown in the form of a wearable computing device. While FIG. 1 illustrates a head-mounted device 102 as an example of a wearable computing device, other types of wearable computing devices could additionally or alternatively be used. As illustrated in FIG. 1, the head-mounted device 102 comprises frame elements including lens-frames 104, 106 and a center frame support 108, lens elements 110, 112, and extending side-arms 114, 116. The center frame support 108 and the extending side-arms 114, 116 are configured to secure the head-mounted device 102 to a user's face via a user's nose and ears, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the head-mounted device 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 114, 116 may each be projections that extend away from the lens-frames 104, 106, respectively, and may be positioned behind a user's ears to secure the head-mounted device 102 to the user. The extending side-arms 114, 116 may further secure the head-mounted device 102 to the user by extending around a rear portion of the user's head. Additionally or alternatively, for example, the system 100 may connect to or be affixed within a head-mounted helmet structure. Other possibilities exist as well.

The system 100 may also include an on-board computing system 118, a video camera 120, a sensor 122, and a finger-operable touch pad 124. The on-board computing system 118 is shown to be positioned on the extending side-arm 114 of the head-mounted device 102; however, the on-board computing system 118 may be provided on other parts of the head-mounted device 102 or may be positioned remote from the head-mounted device 102 (e.g., the on-board computing system 118 could be wire- or wirelessly-connected to the head-mounted device 102). The on-board computing system 118 may include a processor and memory, for example. The on-board computing system 118 may be configured to receive and analyze data from the video camera 120 and the finger-operable touch pad 124 (and possibly from other sensory devices, user interfaces, or both) and generate images for output by the lens elements 110 and 112.

The video camera 120 is shown positioned on the extending side-arm 114 of the head-mounted device 102; however, the video camera 120 may be provided on other parts of the head-mounted device 102. The video camera 120 may be configured to capture images at various resolutions or at different frame rates. Many video cameras with a small form-factor, such as those used in cell phones or webcams, for example, may be incorporated into an example of the system 100.

Further, although FIG. 1 illustrates one video camera 120, more video cameras may be used, and each may be configured to capture the same view, or to capture different views. For example, the video camera 120 may be forward facing to capture at least a portion of the real-world view perceived by the user. This forward facing image captured by the video camera 120 may then be used to generate an augmented reality where computer generated images appear to interact with the real-world view perceived by the user.

The sensor 122 is shown on the extending side-arm 116 of the head-mounted device 102; however, the sensor 122 may be positioned on other parts of the head-mounted device 102. The sensor 122 may include one or more of a gyroscope or an accelerometer, for example. Other sensing devices may be included within, or in addition to, the sensor 122 or other sensing functions may be performed by the sensor 122.

The finger-operable touch pad 124 is shown on the extending side-arm 114 of the head-mounted device 102. However, the finger-operable touch pad 124 may be positioned on other parts of the head-mounted device 102. Also, more than one finger-operable touch pad may be present on the head-mounted device 102. The finger-operable touch pad 124 may be used by a user to input commands. The finger-operable touch pad 124 may sense at least one of a position and a movement of a finger via capacitive sensing, resistance sensing, or a surface acoustic wave process, among other possibilities. The finger-operable touch pad 124 may be capable of sensing finger movement in a direction parallel or planar to the pad surface, in a direction normal to the pad surface, or both, and may also be capable of sensing a level of pressure applied to the pad surface. The finger-operable touch pad 124 may be formed of one or more translucent or transparent insulating layers and one or more translucent or transparent conducting layers. Edges of the finger-operable touch pad 124 may be formed to have a raised, indented, or roughened 20 surface, so as to provide tactile feedback to a user when the user's finger reaches the edge, or other area, of the finger-operable touch pad 124. If more than one finger-operable touch pad is present, each finger-operable touch pad may be operated independently, and may provide a different function.

FIG. 2 illustrates an alternate view of the system 100 illustrated in FIG. 1. As shown in FIG. 2, the lens elements 110, 112 may act as display elements. The head-mounted device 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or LED source and scanning system could be used to draw a raster display directly onto the retina of one or more of the user's eyes. Other possibilities exist as well.

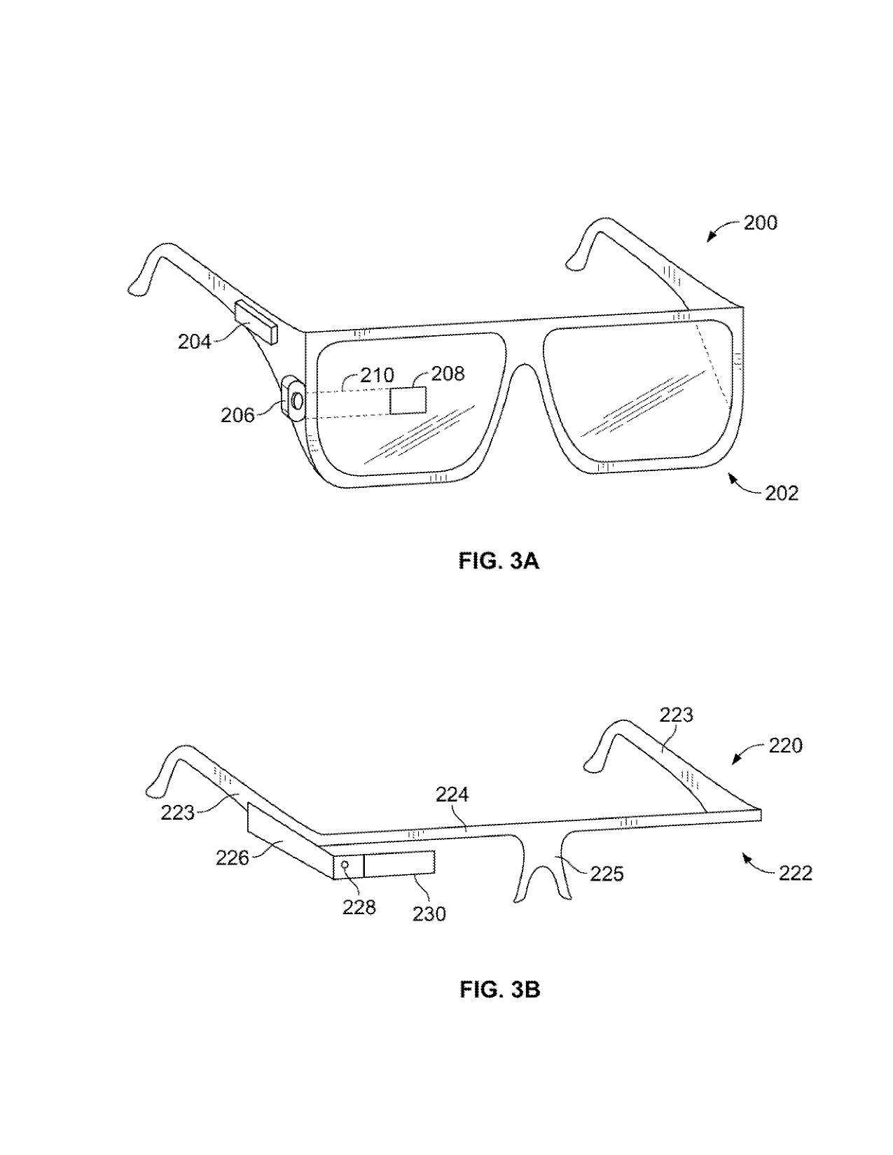

FIG. 3A illustrates an example system 200 for receiving, transmitting, and displaying data. The system 200 is shown in the form of a wearable computing device 202. The wearable computing device 202 may include frame elements and side-arms such as those described with respect to FIGS. 1 and 2. The wearable computing device 202 may additionally include an on-board computing system 204 and a video camera 206, such as those described with respect to FIGS. 1 and 2. The video camera 206 is shown mounted on a frame of the wearable computing device 202; however, the video camera 206 may be mounted at other positions as well.

As shown in FIG. 3A, the wearable computing device 202 may include a single display 208 which may be coupled to the device. The display 208 may be formed on one of the lens elements of the wearable computing device 202, such as a lens element described with respect to FIGS. 1 and 2, and may be configured to overlay computer-generated graphics in the user's view of the physical world. The display 208 is shown to be provided in a center of a lens of the wearable computing device 202, however, the display 208 may be provided in other positions. The display 208 is controllable via the computing system 204 that is coupled to the display 208 via an optical waveguide 210.

FIG. 3B illustrates an example system 220 for receiving, transmitting, and displaying data. The system 220 is shown in the form of a wearable computing device 222. The wearable computing device 222 may include side-arms 223, a center frame support 224, and a bridge portion with nosepiece 225. In the example shown in FIG. 3B, the center frame support 224 connects the side-arms 223. The wearable computing device 222 does not include lens-frames containing lens elements. The wearable computing device 222 may additionally include an onboard computing system 226 and a video camera 228, such as those described with respect to FIGS. 1 and 2.

The wearable computing device 222 may include a single lens element 230 that may be coupled to one of the side-arms 223 or the center frame support 224. The lens element 230 may include a display such as the display described with reference to FIGS. 1 and 2, and may be configured to overlay computer-generated graphics upon the user's view of the physical world. In one example, the single lens element 230 may be coupled to the inner side (i.e., the side exposed to a portion of a user's head when worn by the user) of the extending side-arm 223. The single lens element 230 may be positioned in front of or proximate to a user's eye when the wearable computing device 222 is worn by a user. For example, the single lens element 230 may be positioned below the center frame support 224, as shown in FIG. 3B.

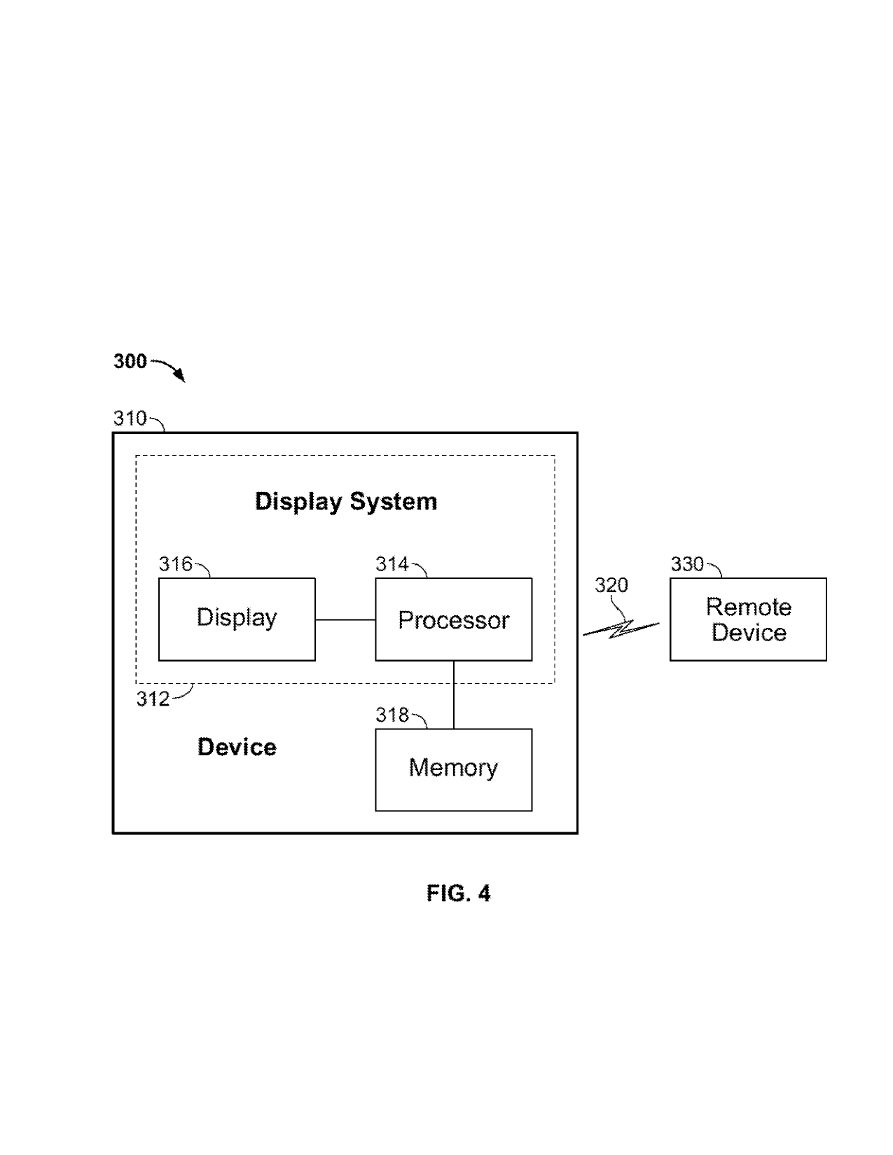

FIG. 4 illustrates a schematic drawing of an example computer network infrastructure. In system 300, a device 310 communicates using a communication link 320 (e.g., a wired or wireless connection) to a remote device 330. The device 310 may be any type of device that can receive data and display information corresponding to or associated with the data. For example, 10 the device 310 may be a heads-up display system, such as the head-mounted device 102, 200, or 220 described with reference to FIGS. 1-3B.

Thus, the device 310 may include a display system 312 comprising a processor 314 and a display 316. The display 310 may be, for example, an optical see-through display, an optical see-around display, or a video see-through display. The processor 314 may receive data from the remote device 330, and configure the data for display on the display 316. The processor 314 may be any type of processor, such as a micro-processor or a digital signal processor, for example.

The device 310 may further include on-board data storage, such as memory 318 coupled to the processor 314. The memory 318 may store software that can be accessed and executed by the processor 314, for example.

The remote device 330 may be any type of computing device or transmitter including a laptop computer, a mobile telephone, or tablet computing device, etc., that is configured to transmit data to the device 310. The remote device 330 and the device 310 may contain hardware to enable the communication link 320, such as processors, transmitters, receivers, antennas, etc.

In FIG. 4, the communication link 320 is illustrated as a wireless connection; however, wired connections may also be used. For example, the communication link 320 may be a wired serial bus such as a universal serial bus or a parallel bus. A wired connection may be a proprietary connection as well. The communication link 320 may also be a wireless connection using, e.g., Bluetooth® radio technology, communication protocols described in IEEE 802.11 (including any IEEE 802.11 revisions), Cellular technology (such as GSM, CDMA, UMTS, EVDO, WiMAX, or LTE), or Zigbee® technology, among other possibilities. The remote device 330 may be accessible via the Internet and may include a computing cluster associated with a particular web service (e.g., social-networking, photo sharing, address book, etc.).

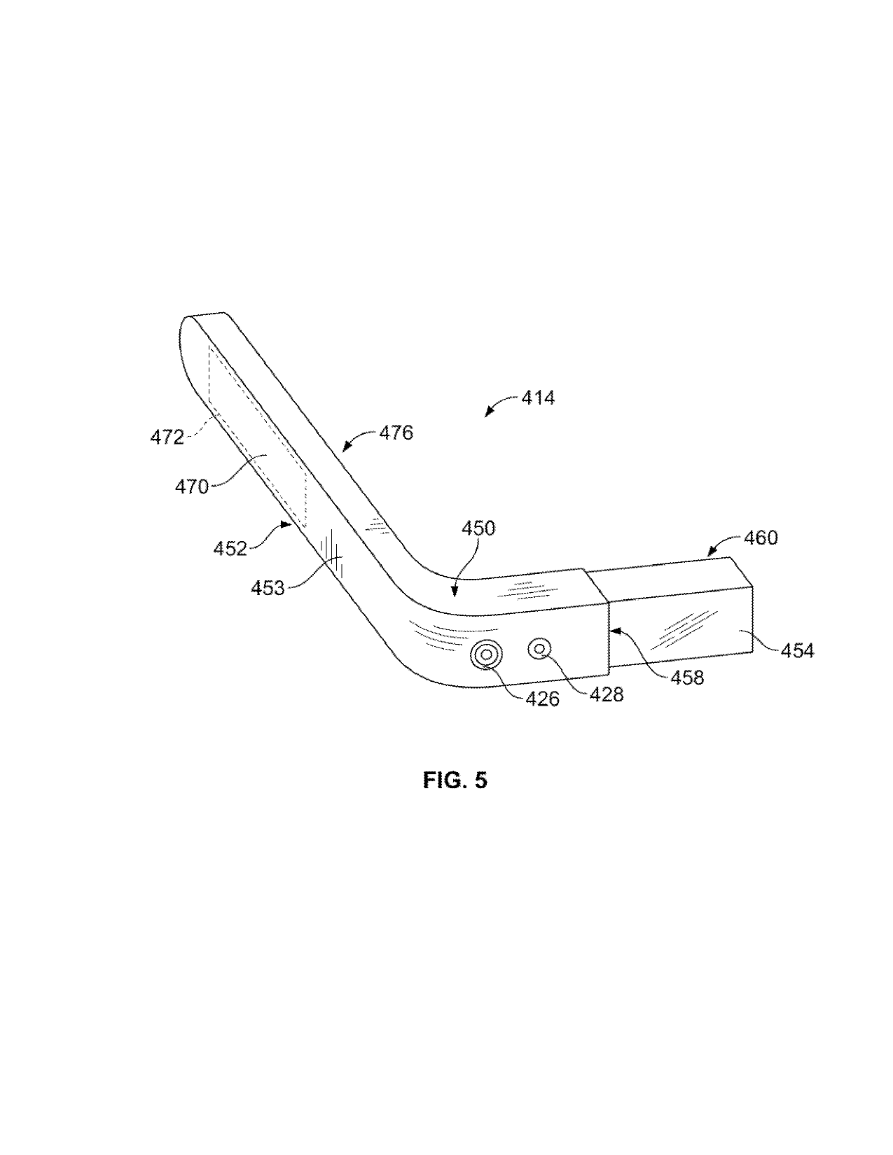

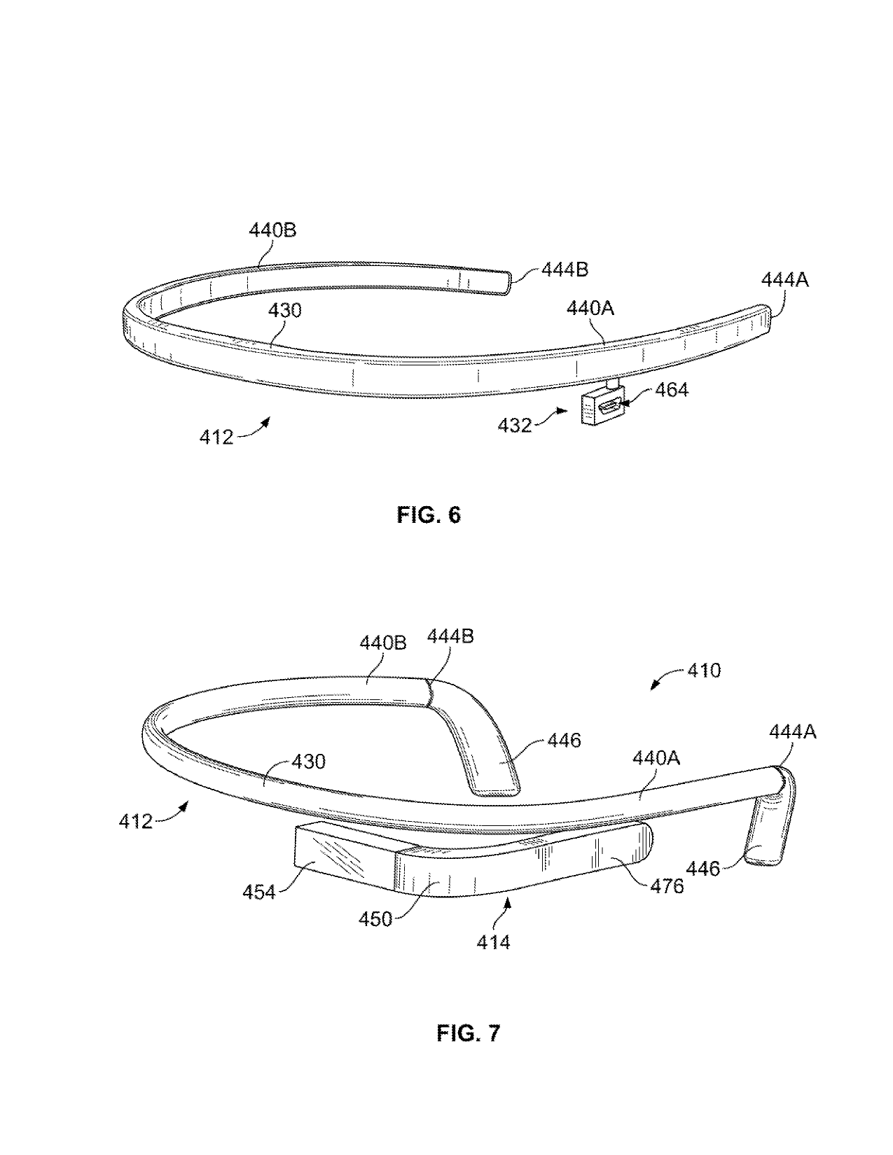

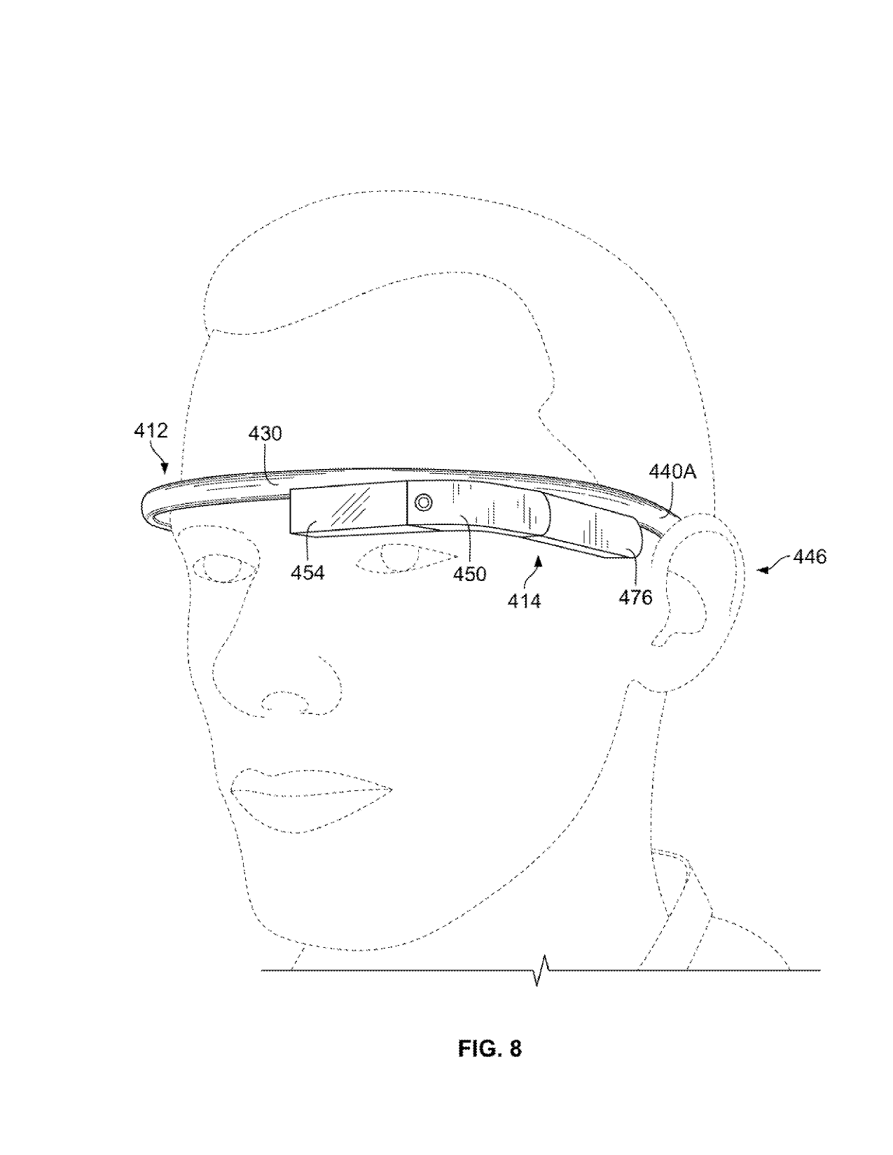

FIGS. 5-15, which do not adhere to the same numbering scheme as used in FIGS. 1-4, illustrate various embodiments of components that can be assembled together to implement the various systems discussed above with reference to FIGS. 1-4. FIG. 5 shows an embodiment of a module 414 that is configured to attach with a number of various forms of wearable structures that fit on the head of a user. For example, Module 414 affixable to a wearable structure in the form of a band 412 (shown in FIG. 6) to form a device assembly 410 (FIG. 7) that is wearable on the head of the user (as shown in FIG. 8). When affixed to such a wearable structure, display 454 of module 414 can be positioned adjacent the user's eye for making an image presented thereon viewable by the user. The module 414 can also include an input device in the form of a touch-based input 470 that is accessible to the user to allow the user to execute a control function of the device assembly 410 or a function of another electronic device that is connected or in communication with device assembly 410.

In the embodiment shown, display 454 is in the form of a generally-transparent prism that is configured to overlay or combine with the user's sight an image generated by electronic display components that are positioned within the housing 452. Such a prism can be structured to receive a projected image in a receiving side 458 and to make that image visible to a user by looking into a viewing side 460 of display 454. This can be done by configuring display 454 with a specific shape and or material characteristics. In the embodiment of FIG. 5 the receiving side 458 of display 454 is adjacent to or within housing 452 such that the electronic components inside housing 452 can contain a video projector structured to project the desired video image into receiving side 458 of prism 454. Such projectors can include an image source such as LCD, CRT, and OLED displays and a lens, if needed, for focusing the image on an appropriate area of prism 454. The electronic components associated with display 454 can also include control circuitry for causing the projector to generate the desired image based on a video signal received thereby. Other types of displays and image sources are discussed herein and can also be incorporated into module 414. Further, a display can be in the form of a video screen consisting of, for example, a transparent substrate. In such an example, the image generating means can be circuitry for a LCD display, a CRT display or the like positioned directly behind the screen such that the overall display is not transparent. The housing of the boom can extend behind the display and the image generating means to enclose the image generating means in such an embodiment.

The receiving surface 458 of display 454 can be perpendicular to the viewing surface 460 of prism 454 such that a transparent prism can be used to combine the projected image with the view of the environment surrounding the wearer of the device. This allows the user to observe both the surrounding environment and the image projected into prism 454. The prism 454 and the display electronics can be configured to present an opaque or semi-transparent image, or combinations thereof, to achieve various desired image combinations.

As discussed above, an input device in the form of a touch-based input 470 is also desirably included in module 414. In the embodiment shown, housing 452 defines an arm portion 476 that can be elongated and can extend at an angle relative to display 454 (which is shown having an elongated shape so as to define a longitudinal axis therethrough). As shown in the figures, arm portion 476 can extend at an angle that can range from about 80° to about 110°. In an embodiment, display 454 is angled with respect to arm portion 476 at approximately 90°. Housing 452 can further be formed to define an elbow portion 450 that supports display 454 relative to arm portion 476 at the desired angle. Elbow portion 450 can be curved, as shown in the figures, or can include a bend formed by a sharp corner or can be configured such that display 454 projects directly outwardly from near arm portion 476 at the desired angle. In an embodiment, the image source associated with display 454 and its related circuitry can be held within housing 452 in elbow portion 450 thereof. Touch-based input can be positioned within arm portion 476 such that, when display 454 is positioned over a user's eye, arm portion 476 is positioned in a position that extends over the user's temple adjacent that eye.

Touch-based input 470 can be a touchpad or trackpad-type device configured to sense at least one of a position and a movement of a finger via capacitive sensing, resistance sensing, or a surface acoustic wave process, among other possibilities. Touch-based input 470 can further be capable of sensing finger movement in a direction parallel or planar to a surface thereof, in a direction normal to the surface, or both, and may also be capable of sensing a level of pressure applied. Touch-based input 470 can be formed having an outer layer of one or more insulating, or dielectric, layers that can be opaque, translucent, or transparent and an inner layer of one or more conducting layers that can be opaque, transparent, or translucent.

In an embodiment, the outer layer of the touch-based input 470 can be a portion of an outer wall 453 of housing 452. This can provide a seamless or uniform incorporation of touch-based input 470 into housing 452. The housing can define an interior cavity for containing the inner layer of the touch-based input 470 and any electrical structures, such as control circuitry, associated therewith. The outer layer of the touch-based input 470 can include the entire wall 453 or a selected operable area 472 in the form of one or more touch-surfaces 470 thereof, as dictated by the size, shape, and position of the inner layer of the touch-based input 470. If a portion of the housing is to be used as the outer layer of the touch-based input 470, then the housing 452 can be made of a dielectric material such as plastic. In an alternative embodiment, the touch-based input can be a discrete element that is mounted in an opening in the housing 452 that includes its own dielectric outer layer, separate from wall 453 to define the operable area within a window or opening through wall 453 in a manner similar to a touchpad on a laptop computer.

In the embodiment shown, touch-based input 470 is positioned on arm portion 476 and defines a vertical plane that overlies a portion of the side of the user's head. Accordingly, touch-based input 470 may not be visible to a user of the assembly 410, when it is being worn. To help the user identify any operable areas 472 of touch-based input 470 the housing 476 can be formed to have a texture provided by a raised, indented, or roughened surface so as to provide tactile feedback to a user when the user's finger contacts the touch surface 472. Such a texture can define the boundaries of the operable area 472, can be consistent through the operable area 472, or can vary along horizontal and vertical lengths of the operable area 472 to give the user feedback as to the location of a finger contacting operable area 472.

Touch-based input 470 can also include additional operable areas 472 on wall 453 or on other portions of housing 452, such as the top or bottom surfaces thereof. This can be achieved by positioning capacitive sensor layers, for example, beneath the selected housing surfaces. In other embodiments, additional touch-based inputs can be provided in different locations of module 413 such as on elbow portion 450. Each of the touch-based inputs 470 can be operated independently, and can provide different functions. Additionally, housing 452 can include additional input structures, such as a button (not shown) that can provide additional functionality for module 414, including implementing a lock or sleep feature or allowing a user to toggle the power for module 414 between on and off states. In an example, such a button can be configured to signal module 414 to capture an image (i.e. to “take a picture”) using camera 426. Such a button can similar in function and location to the button described in the co-pending, commonly-assigned U.S. patent application filed under attorney docket number Google 3.0-388, the entire disclosure of which is incorporated by reference herein.

Touch-based input 470, or another type of input, can be used to provide a control function that is executed by module 414, such as by an on-board CPU or a CPU mounted to or within an associated wearable structure, or by a remote device, such as a smartphone or a laptop computer. In an embodiment information related to the control function is viewable by the user on display 454. In one example, the control function is the selection of a menu item. In such an example, a menu with a list of options can be presented on display 454. The user can move a cursor or can scroll through highlighted options by predetermined movement of a finger along touch-based input 470 and can confirm the selection by a different movement, the acceptance of the selection being indicated by the display. Examples of menu item selections can include whether to answer or decline an incoming call on a remotely-linked smartphone or to scroll or zoom-in on a map presented in display.

Additional input structures can be included in module 414. These can include a camera 426 and a sensor 428, as shown in FIG. 5. The camera can be used to take picture or record a video at the user's discretion. The camera can also be used by the device to obtain an image of the user's view of his or her environment to use in implementing augmented reality functionality. The sensor 428 can be, for example a light sensor that can be used by firmware or software associated with the camera 426. As shown in FIG. 5, the camera and sensor can be included in a housing 452 positioned within the elbow portion 450 and facing in a direction substantially perpendicular to viewing surface 460 of display 454. In such an arrangement, camera 426 is positioned to face in a direction along the user's line of sight, and sensor 428 is positioned to sense light within the view of the camera 426. Other locations for the camera 426 and sensor 428 are also possible.

A wearable structure for assembly with module 414 can be in the form of a band 412, as shown in FIG. 6. Band 412 is shown as having a unitary configuration that generally includes a central portion 430 with arms 440A,440B extending away from opposite sides of the central portion 430. Band 412 can be configured to fit on the head of a user with central portion 430 positioned over the brow of the user such as by extending along a portion of the brow in contact therewith. The portion of the brow that central portion 430 makes contact with can vary, both depending on the size and shape of central portion 430 and the shape of the particular user's head. In an embodiment, the central portion 430 makes contact with enough of the brow to maintain the position of central portion 430 thereon, depending on the fit on the user's head achieved by other features of band 412. Band 412 can be made of or otherwise be covered by a high-friction material, such as rubber, at least in the desired area for such contact. In an embodiment, central portion 430 is in an arched shape to accommodate the generally rounded shape of a human forehead. Band 412 can be constructed of a flexible material to allow central portion 430 to bend in response to different individual brow or head shapes.

Arms 440A,440B can be configured to contact the head of the user along respective temples or in the area of respective ears of the user. Arms 440A,440B include respective free ends 444 opposite central portion 430. Free ends 444 can be positioned to be located near the ear of a user when wearing device assembly 410. Ear portions 446 can be affixed to or integrally formed with the free ends 444 of the arms 440A,440B. As shown in FIG. 7 ear portions 446 can include an arched or curved form, as shown in the figures, such that they bend behind a portion of the rear of the user's ear. As with eyeglasses the particular shape of ear portions 446 can vary in many ways including the amount by which they bend, the distance around the ear which they extend and the amount of contact, if any, actually maintained with the outside of the ear. Arms 440 can be structured to appropriately position ear portions 446 relative to central portion 430 to achieve an appropriate fit for a user or a selection of different users. The shape of arms 440 can, accordingly, depend on the size and shape of central portion 430. For example, arms 440 can extend substantially rearward from central portion 430 substantially perpendicular thereto and can be substantially straight. In other embodiments, arms 440 can be angled inward, outward, upward, or downward relative to central portion 430 and can further be curved in any direction (or multiple directions) to achieve a desired fit or aesthetic quality.

In the embodiment shown, wherein band 412 is a unitary structure, it can be advantageous for band 412 to be made from a resiliently flexible material or combination of materials. Such a construction can permit arms, including ends 444 thereof to flex outwardly away from each other to accommodate heads of different sizes. Further, the structure can be configured so that at a resting, or un-flexed, position (such as when not being worn) band 412 is somewhat smaller than necessary to accommodate the smallest size head that band 412 is configured to be worn on. This may require some degree of flexing by band 412 when worn, resulting in band 412 applying a force against the user's head due to its tendency to return to its undersized resting position. Such a force can help retain band 412 on the user's head, with or without the further retention provided by earpieces 446. As with central portion 430, at least a portion of the arms 440, such as the areas thereof that make contact with the user's head, can be made from or otherwise coated with a rubber or another high-friction material. The use of rubber or the like in these contact areas can also increase the comfort to the user by spreading out the contact more evenly. Such a structure can achieve at least three points of contact with the user's head, which can give a desired level of stability to the assembly 410, when worn. Band 412 can be further configured to provide additional points of contact, such as two points of contact within central portion 430 or continuous contact along the user's head. These types of fit can also result from the particular shape of the user's head.

Suitable materials for band 412 to achieve the above-described characteristics include various plastics, which can be overmolded, co-molded, or insert molded with rubber, such as thermoplastic elastomer (“TPE”) materials in the desired contact areas or covering any relatively harder plastic entirely. Additionally, rubber or TPE can be molded or assembled over metal, such as spring steel or the like. In such an embodiment, a high yield strength metal, such as spring steel can be used to prevent plastic (or permanent) deformation of the desired shape of band 412. Similarly, earpieces 446 can be made from plastic or metal and can be at least partially coated with or covered by rubber or TPE elements for increased friction or comfort.

As mentioned previously, earpieces 446 can be integrally formed with band arms 440 or can be separate elements that can be pre-assembled with arms 440. Alternatively, a number of different earpieces 446 can be provided that can be removably attached to ends 444 of arms 440 according to fit or the user's preferences. In such configurations, earpieces 446 can be made of different materials or material combinations than the remainder of band 412. In a further embodiment, earpieces 446 can extend substantially in-line with arms 440 or can extend inward therefrom, rather than downward, to a position where they rest over the ear on a topmost area thereof but do not hook around the ear. In such an embodiment earpieces 446 or arms 440 can be configured to exert a pressure against the side of the user's head to at least partially retain frame 412 on the user's head using friction generated through the pressure.

In a commercial setting, a number of different bands 412 can be provided that are configured to fit different ranges of head sizes, such as “small”, “medium”, and “large”. These can be provided with a module 414 that is configured to attach to each of the differently-sized bands in a desired manner. Alternatively modules 414 and differently-sized bands 412 can be sold separately, allowing a purchaser to select the desired band and a module to assemble together. Bands 412 in such a setting can also be provided in different fit styles (such as with earpieces or without or in varying shapes) or colors to allow further purchaser customization.

In variations of the band described above, central portion 430 and arms 440A and 440B can each be separate elements that can be affixed together. In one embodiment, arms 440A,440B can be affixed to central portion 430 by hinges to allow the structure to be folded for storage or transportation. Such hinges can be spring-loaded to permit flexure therein instead of in central portion 430 or arms 440A,440B.

Module 414 can attach to band 412 using any one of a number of different structures. In some embodiments it may be advantageous to make such attachment between a location on the arm portion 476 of housing 452 and a location along a corresponding arm 440A or 440B of band 412. As Shown in FIG. 8, module 414 can be affixed to band 412 on either arm 440A or arm 440B thereof to position the display 454 over either the user's right eye or the user's left eye. In an embodiment, module affixes at its arm portion 476 to one of the arms 440A or 440B of band 412 with the arm portion 476 such that when worn it extends along the temple of the user on the side of the arm 440A or 440B toward the front of the user's face. To properly position display 450 at a distance away from the user's eye, arm portion 476 can extend along a longitudinal axis thereof that is tangent to a portion of the arm 440A or 440B (which can be at the point or within the area of attachment) and continues to extend along the longitudinal axis as the band 412 curves inward to contact the user's brow along the central portion 430 thereof. This allows for at least approximately appropriate positioning of display 454 over the user's eye on the side of the arm 440A or 440B to which the module 414 is attached given the angle at which elbow portion 450 positions display 454 relative to arm 476 of housing 452.

Depending on the application of device assembly 410 or individual user preferences, it may be desirable to position module 414 on a particular side of the user's head. For example, a right-handed person may prefer having the module 414 on the right side of her head to make interaction with touch-based input 470 easier. In another example, a person may prefer to have the display 454 over a dominant eye for easier interaction with elements presented on display 454 or over a non-dominant eye to make it easier to shift his focus away from elements presented on display 454 when engaged in other activities. Module 414 can be configured to be symmetrical along a horizontal plane (relative to the general position of module 414 when assembled with band 412 and with assembly 410 being worn by a user) such that module 414 can be rotated along, for example, the longitudinal axis of arm 476 to appropriately position display 454 inward of arm 476 and over the desired eye of the user. In such an arrangement, module 414 can have an attachment structure that is vertically centrally located on arm 476 such that it can be reached by a corresponding attachment feature of band 412 from either side of module. Alternatively, module 414 can include multiple attachment features in appropriate locations to make the desired attachment with band 412 on either arm 440A or 444B. Band 412 can also include attachment features, as will be discussed below, on both arms 440A and 440B to accommodate positioning of module 414 on either side thereof or on one of arms 440A or 440B such that a particular band 412 is designated as being right-side or left-side module attachment.

Module 414 can further be configured to be attached to band 412 such that module 414 is positioned beneath band 412 when in a position as when worn on a user's head. This configuration can be advantageous due to the relative positions desired for display 454 and central portion 430 of band 412. In particular, with central portion 430 in a position over the brow of the user, it may be desired to have display 454 positioned vertically below central portion 430 such that it is in at least a portion of the user's line of sight. Accordingly, in an embodiment this positioning is achieved by attaching module 414 to band 412 such that module 414 is beneath band 412, with exception made for any interacting attachment elements of band 412 or module 414. Other arrangements are possible, such as module 414 attaching to band 412 in an overlapping manner, with module 414 positioned to the outside of band 412 at the point of attachment. In such an arrangement, module 414 can angle downward, as necessary, to appropriately position display 454 relative to the user's eye. This arrangement can also be used to provide an assembly 410 that can be “flipped” to be worn with display 454 over either eye, with module 414 being appropriately rotated to be positioned beneath band 412 regardless of the orientation of band 412 on the user's head.

The attachment between module 414 and band 412 can be configured to allow adjustment between the relative positions of band 412 and module 414. This adjustment can be such that the user can wear band 412 on his or her head in a comfortable position and can then make adjustments to place display 454 in a desired or appropriately functional position. For example, the user may desire to position display directly in her line of sight (both vertically and horizontally) or may desire to have display 454 positioned above, below, or to the outside of his line of sight. Such positioning may vary depending on how the user is using device 410, making on-the-fly adjustments useful for some applications. In other embodiments, discussed below, such adjustment can be made within module 414 itself, allowing a fixed attachment between module 414 and band 412, while still permitting similar adjustments.

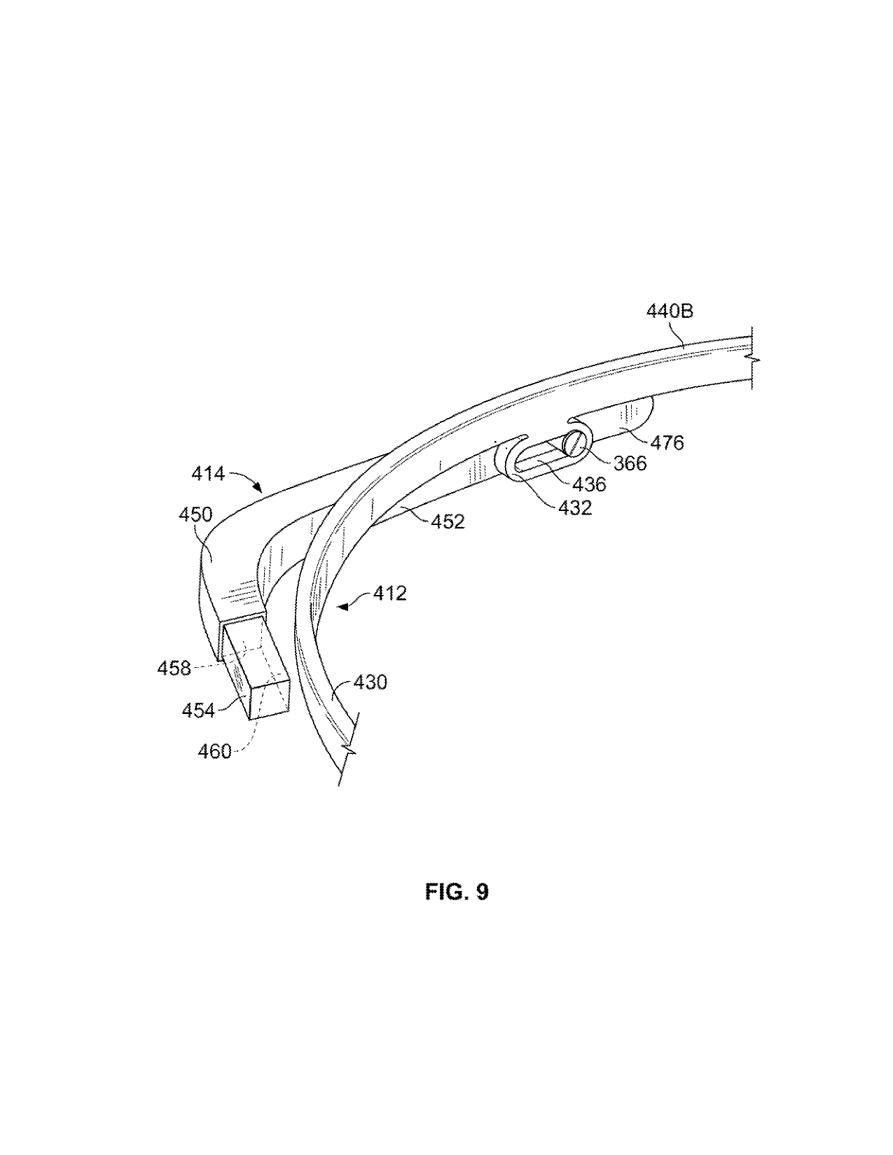

In the embodiment shown in FIG. 9, the attachment feature 432 of band 412 includes a track 436 that extends along a length of arm 440A (a similar feature can also or alternatively be positioned on arm 440B). Module 414 includes an attachment feature 462 including a screw 466, the shank of which fits securely within track 436 with the head of screw 466 extending outward along the body of the attachment feature 432. In such an arrangement, module 414 can be affixed to attachment feature 432 using screw 466 such that module 414 can be moved forward and backward relative to band 412 by sliding screw 466 within track 436. Screw 466 can then be tightened into housing 452 to secure the position of module 414 relative to band 412. Such adjustment can provide various forms of “eye relief” such as by compensating for different eye positions such as for users with deep-set eyes or with eyes positioned relatively close to brow. Additionally, the eye relief provided by the forward and backward adjustability of attachment 432 can allow display 454 to be positioned clear of the user's eyelashes including those of users with relatively long eyelashes. Screw 466 can then be tightened into housing 452 to secure the position of boom 414 relative to band 412. Housing 452 can be configured to permit some rotation of module 414 relative to attachment portion 432 such that the rotational position of module 414 can also be fixed by tightening screw 466 into housing 452. This attachment can also incorporate a spring (not shown) or the like positioned between housing 452 and attachment feature 432 such that module 414 is biased away therefrom. This can allow the lateral position of module 414, and thus display 454, to be adjusted by tightening screw 466, which can draw housing 452 closer to attachment feature 432. In either arrangement, module 414 can be disassembled from band 412 by loosening screw 466 until it is removed from housing 452. Other, similar arrangements are possible, including sliding joints such as dovetails or the like, which can be locked in place using set screws or the like.

Track 436 can include conductive features such as exposed wire segments or traces partially embedded therein that can align with further conductive features positioned on housing 452 of module 414 to allow connection between electronic elements in the band 412 and the electronic components (including the image source or touch-based input 470) in module 414. In other embodiments, an external wire (not shown) can extend out from band 412 and plug into an outlet (not shown) on module 414 to achieve a desired electrical connection therebetween. Band 412 can include additional wires that run through at least a portion thereof to further connect such components that may be located remotely from each other.

The attachment feature 432 in the embodiment of band 412 shown in FIG. 6 includes a universal serial bus (“USB”) port 434 therein. A module 414 configured to attach to such a band 412 can include a mating USB plug such that assembly of the mating USB port and plug attaches module 414 to band 412 (with or without the assistance of additional snap or track type connections). In such an embodiment, the USB plug 434 (or another, similar computer-type attachment) can connect electronic components within module 414 (such as the image source) with an electronic element within band 412 (such as a battery within an earpiece 446 or a circuit panel embedded in arm 440A,440B). The attachment feature 432 can be configured to tilt or slide relative to the arm 440A or 440B to which it is attached to allow adjustment similar to that which is discussed above.

As mentioned previously, housing 452 can contain electronic circuitry such as the circuitry for touch based input 470. In addition housing 452 can include control circuitry for the image source associated with display 454, the camera 426, or the sensor 428, or one or more circuit boards including a processor to control display 454, touch based input 470 or to perform other functions for module 414. Housing 452 can further include a power source, such as a battery to power the other circuitry. Additionally housing 452 can include memory, a microprocessor or communications devices, such as cellular, short-range wireless (e.g. Bluetooth), or WiFi circuitry for connection to a remote device. Additionally, any such circuitry can be included in band 414 such as in at least one of the earpieces 446, for example in an internal cavity thereof. As shown in FIG. 7, earpiece 446 can be configured to be positioned behind or over the ear of the user while being worn. Earpiece 446 can be further configured to contact a portion of the user's head to help secure the position of device assembly 410. Earpiece 446 can be configured to include a battery or multiple batteries of various forms, such as AAA, AA, or 9-volt style batteries. The battery can also be a rechargeable battery such as a lithium-ion or nickel-cadmium battery and can be removable by the user or can be permanent or semi-permanent. Earpiece 446 can also include a port (not shown) that can be used to connect device assembly 410 to a power source to recharge a battery without removal thereof or to connect device 410 to a remote device for communication therewith, such as described above, or to update or install software or firmware included in the memory of device 410.

Earpiece 446 can be configured and positioned to provide a balancing weight to that of module 414. Module 414 is positioned forward of the user's ear, which can cause a portion of its weight to be supported over the brow of the user. By adding weight behind the user's ear (or shifting weight to behind the user's ear) in the form of earpiece 446, the ear becomes a fulcrum about which the weight of module 414 is balanced against that of the earpiece 446. This can remove some of the weight on the user's brow, giving a more comfortable, and possibly a more secure fit with reduced potential slipping of central portion 430 downward on the user's brow. The components within earpiece 446, such as a battery or various control circuitry can be arranged to contribute to a desired weight distribution for device assembly 410. For example, heavier components, such as a battery, can be placed toward or away from module on arm 440A to adjust the weight distribution. In an embodiment, a majority of the weight can be carried by the ear of the user, but some weight can still be carried by the brow in order to give the device a secure feel and to keep the central portion 430 in a desired position on the brow to maintain a desired position for display 454. In an embodiment, between 55% and 90% of the weight of device assembly 410 can be carried by the user's ear.

In the present example, a single module 414 is shown attached to band 412. Alternatively, two modules could be included, with one affixed on each arm 440A and 440B of band 412 and corresponding to each eye of the user. As a further alternative, a single display 454 could be used with a prism or other structure configured to extend over both eyes of the user for displaying an image viewable by both eyes.

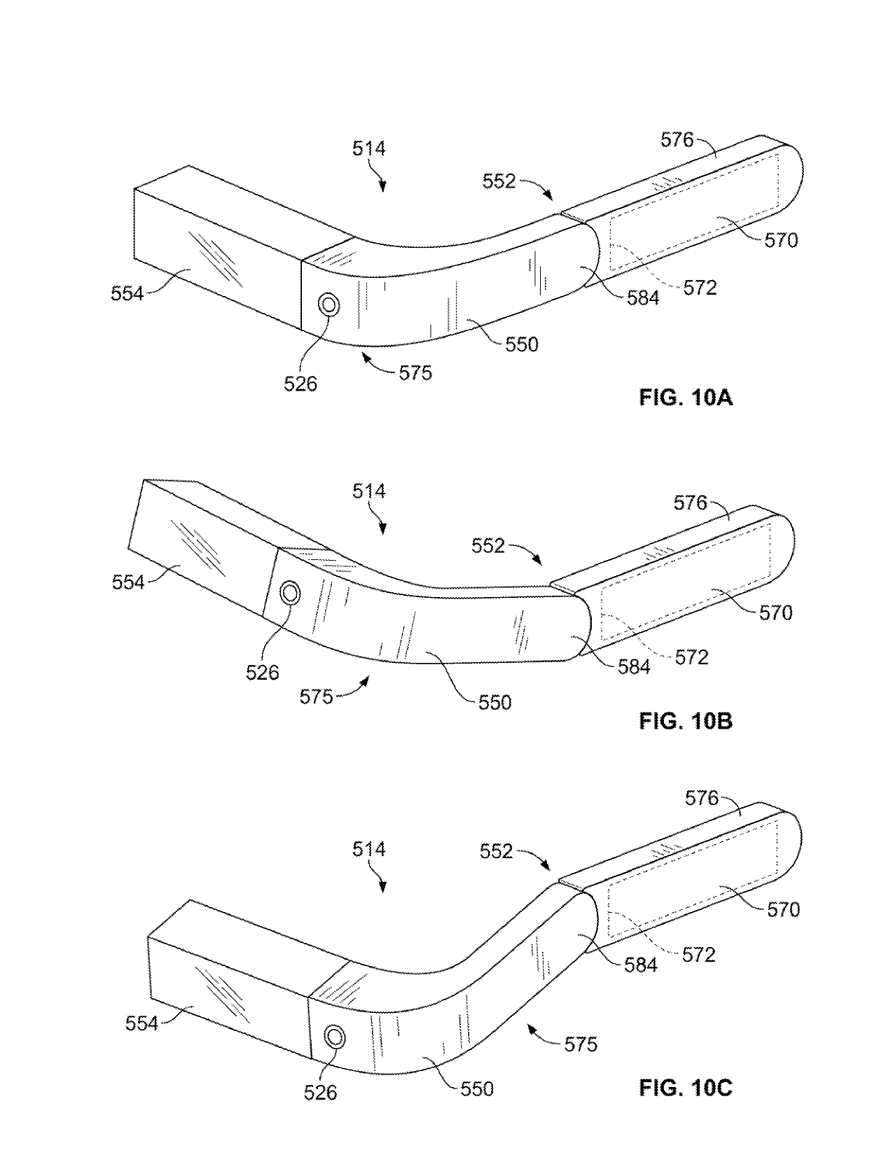

FIG. 10A shows another embodiment of a module 514 for attachment with a band 512. In this embodiment, the band can be similar to the various forms of bands (for example band 412 shown in FIGS. 6-9) discussed above and can attach thereto in a similar manner using similar forms of attachment structures. The module 514 of FIG. 10A is shown in a configuration to fit over a right eye of a user in a general form that is a mirror image of a form, such at that of FIG. 5, that is configured for use over a user's left eye. As with the embodiment of FIG. 5, the embodiment of FIG. 10A can be mirrored or inverted in a version that can be worn over the user's left eye. In the embodiment of FIG. 10A, housing 552 is divided into a display housing 575 and an arm housing 576. As shown, display housing 575 defines elbow portion 550 and has display 554 mounted thereon. Arm housing 576 substantially defines the arm portion of module 514 and can include touch-based input 570, which can be a discrete element or can be an operable surface 574 of housing 552, as described above with respect to FIG. 5. In an embodiment, the display portion 575 and arm portion 576 of housing 552 can be covered by a compliant outer layer (not shown). This outer layer can be made from a rubber material, for example, and can cover any joint between the two housing portions to give module 514 a clean and uniform look. A rotating joint between display portion 575 and arm portion 576 can be used and can be formed by a separate element such as a pin or by integrally-formed features such as a post and a mating hole that can snap together. Additionally, an armature wire, a gooseneck feature, or a ball-and-socket joint can be assembled between the display portion 575 and the arm portion 576 to allow adjustment along additional axes. Such joints can also be covered by a compliant outer layer.

In this embodiment, display housing 575 can be rotatably affixed to arm housing 576. Module 514 can then be attached to band 512 by any of the structures discussed above. The rotation of display housing 575 can implement an additional or alternative form of adjustment for the position of display 554 relative to the user's eye. As shown in FIG. 10B, display housing 575 can be rotated upward relative to arm housing 576. Further, as shown in FIG. 10C, display housing 575 can be rotated downward relative to arm housing 5576. In an embodiment, the point of rotation 584 between display housing 575 and arm housing 576 can be positioned near the focal center of a user's eye. This can be approximated based on predetermined non-adjustable attachment structures on bands of varying sizes, as discussed above, or can be done though forward- and backward-adjustable attachment structures, such as those described above with respect to FIG. 9.

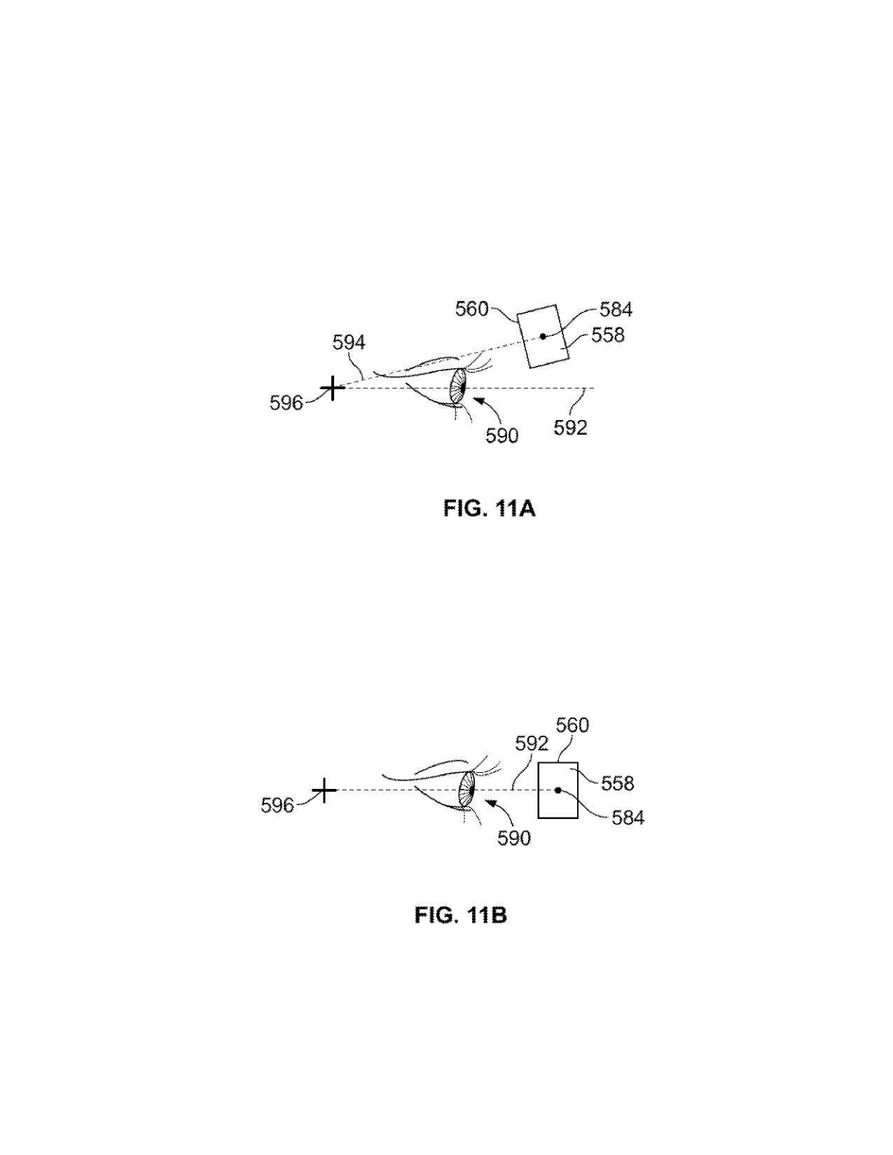

As shown in FIGS. 11A-B, in certain structures of display 554, such as certain display configurations (including the use of some types of prisms), it can be beneficial to orient display 554 such that viewing surface 560 is normal to a line from the image location within display 554 to the focal center of the user's eye. By allowing rotation of display housing 575 and, thus, display 554 to rotate relative arm housing 576, the display 554 can be positioned in an optimal angle for viewing by users with different facial structures and different preferences for the horizontal or vertical position of display 554 or band 512. FIG. 11A shows display 554 at a location above the horizontal center 592 of the user's eye 590. Display 554 is pivoted or otherwise rotated about axis 584 that extends in a lateral direction relative to the user's face (in and out of the page of FIG. 11A) such that surface 560 is perpendicular to a line 594 extending between surface 560 and the focal center 596 of the user's eye 590. It is noted that the diagram shown in FIG. 11A is only an example and different users can have different locations of their eye's focal center. FIG. 11B shows display 554 positioned vertically near the horizontal center 592 of the user's eye with display rotated accordingly for optimal viewing by the user, as described above.

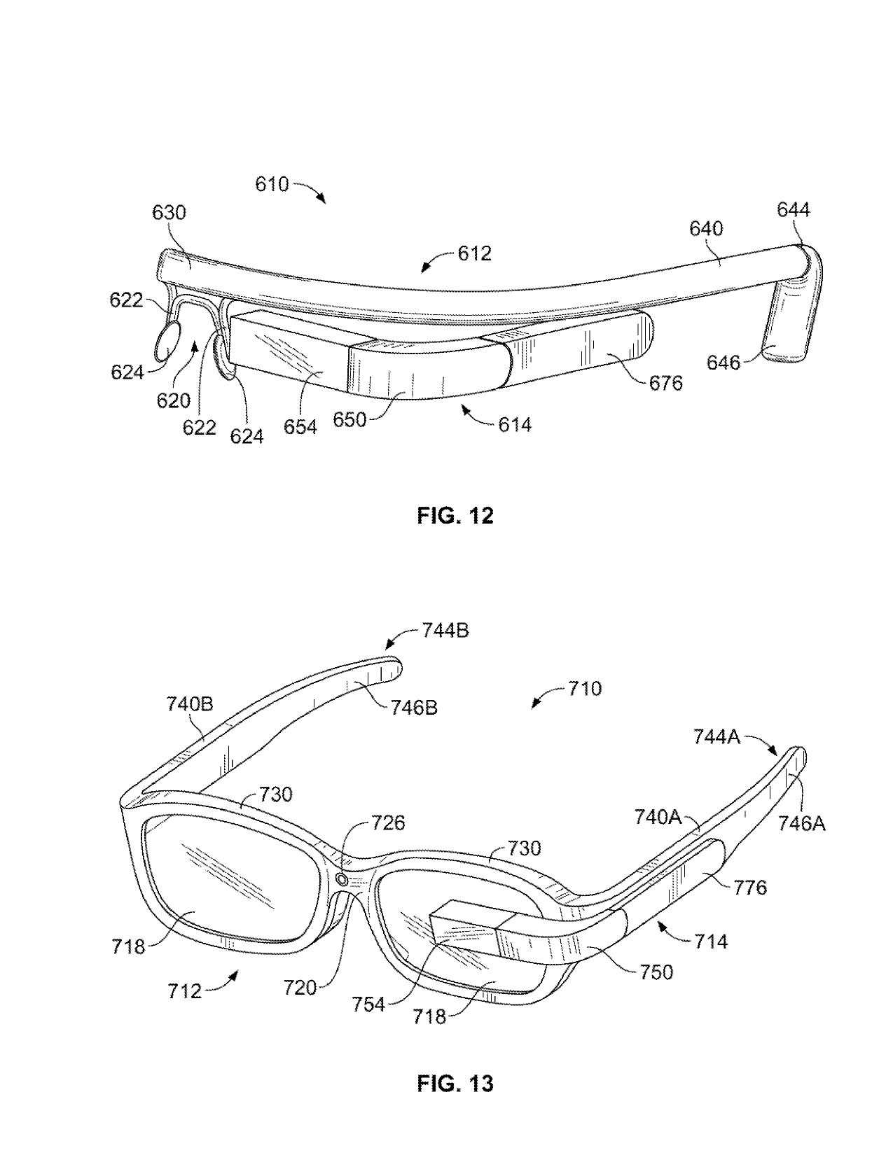

FIG. 12 shows an alternative structure for band 612 in which central portion 630 thereof includes a nosebridge 620 affixed thereto such that band 612 can extend to an arm 640 that is positioned only on the side of the user's head to which module 614 is attached. In the embodiment shown, nosebridge 620 includes a pair of bridge arms 622 that extend from the central portion 630. In the view of the embodiment of device assembly 610 shown in FIG. 12, bridge arms 622 extend in a downward direction from central portion 630. As in other figures, the orientation of device assembly 610 shown in FIG. 12 generally corresponds to the orientation of device 610 when being worn by a user when the user's head is in a neutral, upright position. The description of bridge arms 622 extending downward from central portion 630 is made in such a reference frame and is done for purposes of the present description. Discussion of any other relative reference directions is also made for similar purposes and none are intended to be limiting with respect to the present disclosure, unless explicitly stated.

Bridge arms 622 can include respective pads 624 thereon, which can be positioned to rest on parts of the nose of the wearer. Pads 624 can be made of a material that is softer than arms 622 for purposes of comfort. Additionally the material that pads 624 are made from can be flexible or have a texture that prevents slippage along the surface of the user's nose. Bridge arms 622 can be flexible to further provide a comfortable fit and or grip on the user's nose. Further, bridge arms 622 can be deformably bendable and repositionable so that the position of pads 624 can be changed to best fit the user. This can include movement closer together or farther apart or fore and aft relative to central portion 630, which can adjust the height of central portion 630 and, accordingly, the position of module 614 and its display 654 relative to the user's eye. Further adjustment of display and other structures thereof can be similar to those in the embodiments described above, as can the structures used to affix module 614 to band 612. In other embodiments, structures similar to arms and pads can be integrally formed with central portion 630 and can be structured such that larger or smaller areas of the nosebridge 620 contact the nose of the user, compared to the embodiment shown. Additionally, a nosebridge having a similar structure to that shown in FIG. 12 can be used in connection with the structure of device assembly 610 and 410 shown in FIGS. 5-9.

The weight distribution of device assembly 610 can be configured in a similar manner to that which was described above with respect to the embodiment of FIG. 7. In some embodiments, however, it may be desired to have a comparatively greater portion of the weight borne by the user's nose. For example, the weight balancing can be configured such that between 40 and 75% of the weight of assembly 610 is applied to the user's nose. Further, it may be desired to configure earpiece 646 such that the weight thereof is centered laterally inward of the user's ear. In the embodiment shown in FIG. 12, earpiece angles inward as it curves downward such that it extends along a portion of the user's head behind the ear in a direction toward the middle of the back of the head. In such a configuration, the weight of earpiece 646, in addition to balancing against the weight of module 614 in front of the user's ear, can impart an inward twisting force on arm 644, which is then transferred through central portion 630 to the user's nose by nosebridge 620. This can help to balance against any weight force exerted by module 614 laterally outside the user's ear, which could cause assembly 610 to sag on the user's head. Such balancing can further help to secure nosebridge 620 on the user's nose.

As shown in FIG. 13, an assembly 710 can include a module 714, similar to that which is described in other embodiments above paired with a wearable structure in the form of eyeglasses 712 that are adapted for connection with module 714. In general, frame 712 can be similar to a frame associated with prescription glasses or sunglasses.

Frame 712 also includes one or more rims 730 that extend in a lateral direction away from bridge 720. The embodiment shown includes two rims 730A and 730B, each extending away from opposite sides of bridge 720. In some embodiments, the rims 730 can be integrally formed with or can be substituted with a specially structured lens. Rim 730A,730B are shaped to extend laterally past the user's eye while being positioned at least above the eye so as to not obstruct the wearer's vision. Rims 730 are further structured to hold respective lenses 718 over the user's eyes. As such, in some embodiments rims 730 can fully encircle lenses 718 and, accordingly, the user's eyes. Other “half-rimed” or “rimless” configurations can be implemented in a similar structure. Additionally, lenses can be assembled with a band, similar to that shown in FIGS. 6-8, that includes a nosebridge according to the embodiment of FIG. 12. In such an embodiment, the lenses can depend downwardly from the band to cover the user's eyes. A number of different shapes and structures are possible for rims 730A,730B, in addition to what is shown in the figures. The specific shape of rims 730A,730B can depend on the shape and structure of bridge portion 720 or lenses 718 or can be configured for aesthetic or stylistic purposes.

Rims 730A,730B can be of the same or a different material from nosebridge 720. Examples of suitable materials for the rims 730, or any other part of frame 712, can include various types of thermoplastic such as polycarbonate, acrylic, ABS, and polyethylene or resin plastics such as urethane or the like. Any parts of frame 712, including the nosebridge 720 and rims 730, can be made from metal such as aluminum, stainless steel, titanium, nickel, gold, or various alloys including one or more of the metals listed or similar metals. Rims 730 can be monolithically formed with nosebridge 720 from the same material, or rims 730 and nosebridge 720 can be made from different materials and affixed together using adhesives, screws, various forms of welding, soldering, braising, or the like.

Frame 712 also includes one or more arms 740A,740B that extend from the rims 730A,730B, past the user's temple, and toward the user's ear. As shown in FIG. 13, frame 712 can include two arms 740A,740B that can be positioned to extend in a rearward direction from respective rims 730A,730B. Arms 740A,740B may provide additional points, or areas, of contact with the user's head and contribute to the device's fit and retention to the user's head. Arms 740A,740B can be similar in structure or function to corresponding features of eyeglasses or similar to the arms of the band in the embodiment described with respect to FIGS. 6-9, above.

Arms 740A,740B can be integrally formed with respective rims 730A,730B. Alternatively, arms 740A,740B can be affixed to respective rims 730A,730B using a hinge member arranged to permit arms 740A,740B to be folded inward toward brow portions 730 for storage or transportation. If hinges are used, they can be spring-loaded or the like to apply a comfortable pressure against the user's head or to accommodate a range of different head sizes comfortably. In some embodiments, arms can be made of a plastic material with internal metal reinforcement to allow bending or to prevent breakage.

Arms 740A,740B include respective free ends 744 opposite the respective rims 730A,730B. Free ends 744 can be positioned to be located near the ear of a user when wearing device assembly 710. Ear portions 746 can be affixed to or integrally formed with the free ends 744 of the arms 740A,740B. As shown in FIG. 12 ear portions 746 can include an arched, or curved, form, as shown in the figures, such that they bend behind a portion of the rear of the user's ear. As with eyeglasses, the particular shape of ear portions 746 can vary in many ways including the amount by which they bend, the distance around the ear which they extend and the amount of contact, if any, actually maintained with the outside of the ear. In the example shown, ear portions 746 can have a subtly-arched form; however, other embodiments of ear portions can have a more pronounced curvature. For example, a frame 712 can have ear portions similar to those shown on the band 412 of FIG. 7. Ear portions 746 can be configured to include various electronic components in a similar manner to the ear portions 446 discussed with respect to FIGS. 6-9. Such electronic components can include batteries, control circuitry, communication devices, and the like, which can be connected with module 714 by wires, traces or the like embedded within arms 740.

Arms 740 can be structured to appropriately position ear portions 746 relative to rims 730 to achieve an appropriate fit for a user or a selection of different users. The shape of arms 740 can, accordingly, depend on the size and shape of rims 730. For example, arms 740 can extend substantially rearward from their respective rims 730 substantially perpendicular thereto and can be substantially straight. In other embodiments, arms 740 can be angled inward, outward, upward, or downward relative to the outside ends of rims 730 and can further be curved in any direction (or multiple directions) to achieve a desired fit or aesthetic quality.

Module 714 can be configured to attach to one of arms 740A or 740B only or selectively to either one of arms 740A and 740B. Any of the above-described structures can be used to achieve such connection. Further, such structures can be configured to attach module 714 beneath one of arms 740A,740B or on an outside surface thereof, as shown in FIG. 13. Module 714 can be adjusted to appropriately position display 754 over the user's eye at the point of attachment to arm 740A or 740B or module 714 can have a housing 752 that is split into display and arm portions that rotate relative to each other as shown in FIGS. 10A-C. Module 714 can include a camera, as shown in other embodiments herein (for example camera 426 in FIG. 5). In other embodiments, a camera 726 can be included in frame 712, such as in nosebridge 720. Camera 726 can be included in other locations within frame 712 as well, including in a portion of arm 740B opposite the arm 740A to which module is attached. Camera 726 can connect through an attachment structure (which can be similar to other attachment structures discussed herein) to control circuitry within module 714 or can connect through embedded wiring to other control circuitry that can be positioned within another portion of frame 712, such as a cavity within, for example arm 740B, or within an earpiece 746A or 746B.

In an embodiment, the various modules and wearable structures described herein can be configured to be interchangeable among each other such that any one of the embodiments of modules can be used with any one of the types of wearable structures also described. Such configuration can include those in which the modules and wearable structures are shaped and sized according to similar principles regarding fit, weight distribution, appearance, display position, and adjustability. Further, all such modules and wearable structures can implement a common form of attachment structure for attaching the modules to the wearable structures, including any of those described above.

Various combinations of modules and wearable structures can be packaged in kits. In an example, a module, such as module 414 in FIG. 5 can be made commercially available in a kit with a band such as band 412 in FIG. 6 and a half-band 614 as shown in FIG. 12 or other bands 412 of different colors or ear portion 446 configurations. In another embodiment, a module such as module 414 can be made commercially available in a kit with a plurality of differently-styled eyeglass-type frames similar to what is shown in FIG. 13. In yet another embodiment, a module 414 can be packaged in a kit with a band 412 and a pair of eyeglass-type frames 712 with tinted lenses for use as sunglasses. The different types of wearable structures in such a system can include specially-configured chips or other electronic circuitry such that the module can identify they type of wearable structure to which it is attached. This can allow the module to automatically adjust settings or select between sets of preconfigured settings, based on the structure to which it is attached.

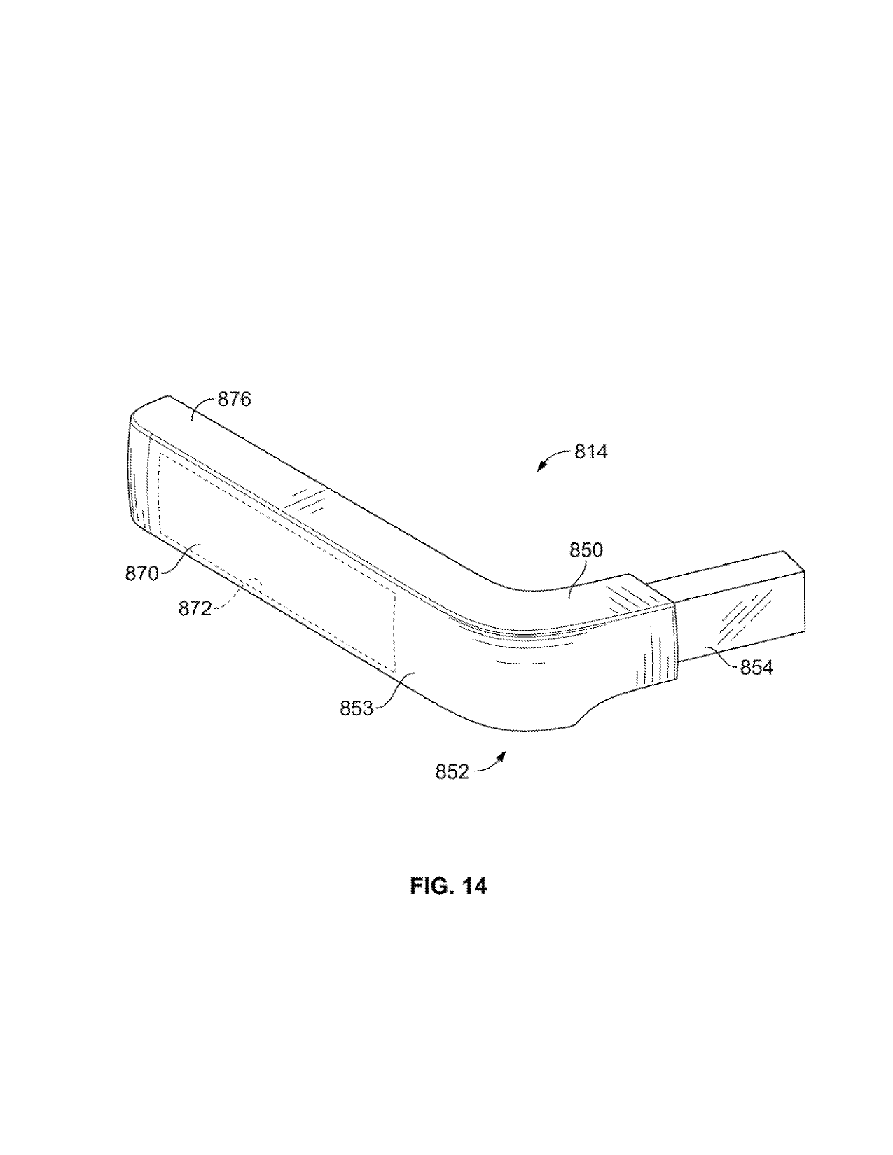

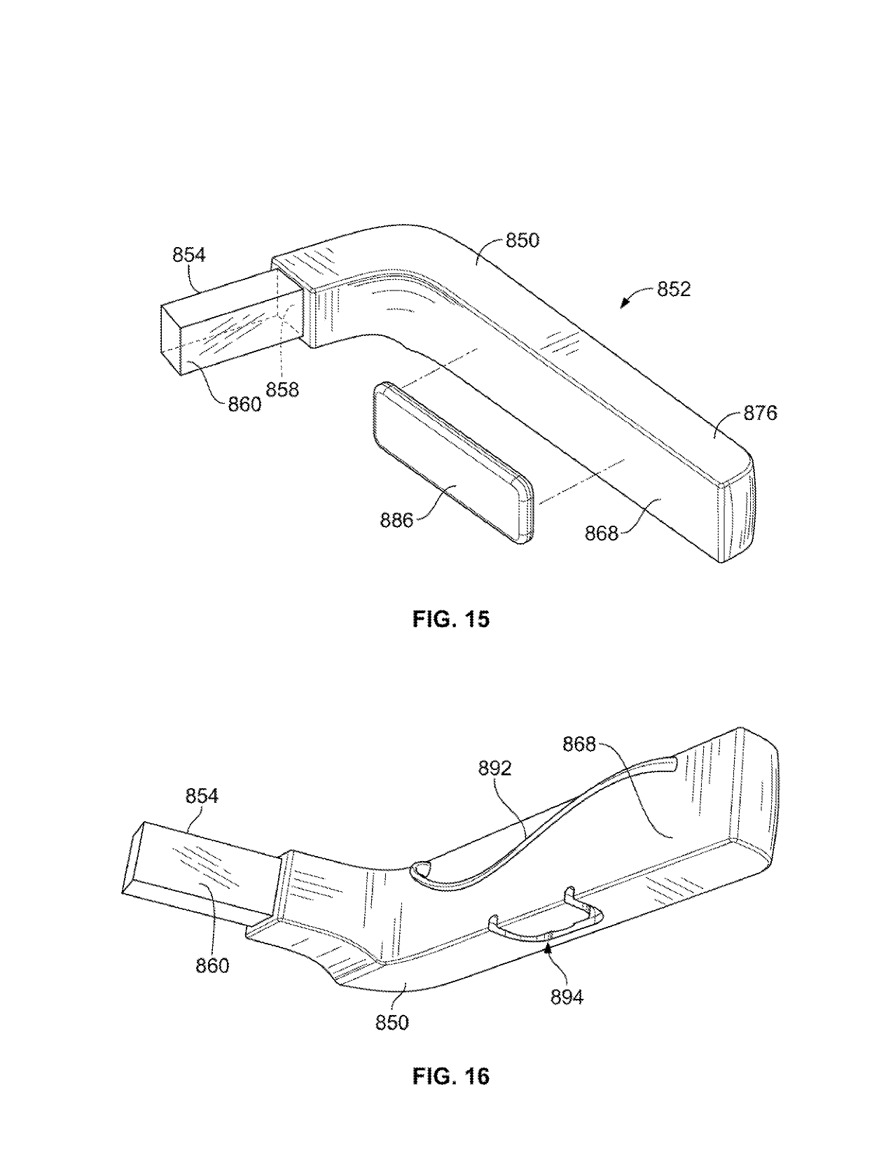

In another embodiment, the module can be configured to operate on its own, without connection with one of the wearable structures described above. In one aspect, the module can have all of the electronic components (image source, touch-based input, electronic circuitry, power source, etc.) contained within its housing so that it does not need to be connected with a wearable structure having operational features therein. The modules shown in FIGS. 5-13 can be configured to function as stand-alone modules. Additionally, FIGS. 14 and 15 show another example of a module 814 in which housing 852 of module 814 can be comparatively larger than that which is shown in other examples. This can be done to accommodate all necessary operational components or to accommodate larger or additional components, including a larger battery, flash memory, high-definition image sources, high-resolution cameras, etc. Such a stand alone module can be configured for use with other items that are worn on individuals' heads, such as eyeglasses, sunglasses, hats, visors, etc. In an example, housing 852 can contain a magnet or magnets therein adjacent a wall thereof that defines inside surface 868 such that the magnet can attach module 814 to items with metal components, such as the arms of eyeglasses and the like.

In a further example shown in FIG. 15, a separate magnetic element 886 can be provided that can be used with module 814 to capture a portion of another item therebetween, the assembly thereof being secured by mutual magnetic attraction between the magnetic element 886 and the magnets internal to housing 852. Such an assembly can, for example, be used to attach module 814 to the crown portion of a hat or to arms of eyeglasses, including those that do not contain any ferromagnetic metals. Both the inside surface 868 of housing 852 and the magnetic element 886 in such an embodiment can be coated with or at least partially made from a non-abrasive high-friction material such as rubber or a TPE to further help secure the parts in place in an assembly.

FIG. 16 shows a further example in which module 814 includes a strap 892 extending from inside surface 868 of housing 852. Strap 892 can be made from a flexible material that can further be elastic or elastomeric to allow both flexibility and stretching thereof. Housing 652 can further include a channel 894 or other feature to receive and releasably secure strap 892 therein. This arrangement allows a portion of a head-worn item to be positioned adjacent to inside surface 868 where strap 892 can be looped around the portion with the strap 892 received in channel 894 to secure module 814 to the particular head-worn item. In an example, strap 892 can be looped around the arm of a pair of glasses to removably attach module 814 thereto. In other examples, a simple clip can be positioned on an inside surface of the housing 852 that can be used to attach the module 814 to a head-worn item to position display 854 over an eye of the user.

Additional components can be included in the various device assemblies described herein. These components can include additional inputs, control circuitry boards, antennae or the like. The various locations in which these additional components are located on or in such a device assembly can also be selected to allow for a predetermined weight distribution.

Although the description herein has been made with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1. An electronic device for use with a wearable structure configured to be worn on the head of a user, the device comprising:
a display element;
a housing including an arm portion and an elbow portion, the housing being configured to be removably affixed to the wearable structure at the arm portion thereof, and the elbow portion defining a display end of the housing that supports the display element, wherein the arm extends along a longitudinal axis of the housing, and wherein the elbow portion is configured such that the display end supports the display element along a display axis disposed at an angle with respect to the longitudinal axis;
image generating means disposed within the housing and configured for generating an image presentable to the user on the display element; and
an input device affixed to the housing and configured for receiving from the user an input associated with a function, the function being related to information that is presentable on the display element.

2. The device of claim 1, wherein the display element is a generally transparent prism configured to combine the image presentable to the user thereon with a user view through the display element.

3. The device of claim 1, wherein the display axis is angled at between about 80° and 110° with respect to the longitudinal axis.

4. The device of claim 1, wherein the elbow portion is curved so as to extend away from the arm portion in an arcuate fashion to the display end of the housing.

5. The device of claim 4, wherein the arm portion has a first thickness and the display element has a second thickness greater than the first thickness, and wherein the elbow portion tapers from the first thickness at a location adjacent the arm portion to a second thickness at the display end thereof.

6. The device of claim 1, wherein the input device is positioned in the arm portion, and wherein the image generating means are positioned in the elbow portion.

7. The device of claim 1, wherein the housing is configured to be removably affixed to the wearable structure such that the display element is positionable over an eye of the user.

8. The device of claim 1, wherein the housing includes a first snap fit element that is configured to releasably engage with a second snap fit element included on the wearable structure, and wherein the housing is configured to be removably affixed to the wearable structure by the releasable engagement between the first and second snap fit elements.

9. The device of claim 1, wherein the housing includes a first track element that is configured to slideably and releasably engage with a second track element included on the wearable structure, and wherein the housing is configured to be removably affixed to the wearable structure by the releasable engagement between the first and second track elements.

10. The device of claim 9, wherein the slidable engagement between the first and second track elements is configured to allow adjustment of the display element toward and away from an eye of the user.

11. The device of claim 1, wherein the device further includes a first electronic element coupling attached to the housing and in electrical communication with at least the image generating means, the first electronic element coupling being configured to releaseably engage with a corresponding second electronic element coupling included on the wearable structure, and wherein the housing is configured to be removably affixed to the wearable structure by the releasable engagement between the first and second electronic element couplings.

12. The device of claim 11, wherein the first electronic element coupling is a universal serial bus coupling.

13. The device of claim 11, wherein the first electronic element coupling is configured to provide for connection between the image generating means and an electronic element of the wearable structure.

14. The device of claim 1, wherein the electronic device further includes a camera having a lens thereof, the camera being attached to the housing such that the lens thereof is exposed on the housing within the elbow portion and is directed substantially parallel to the longitudinal axis.

15. The device of claim 1, wherein the arm portion and the elbow portion are discrete elements rotatably affixed to each other about an axis substantially parallel to the display axis.

16. The device of claim 1, further including a first magnetic element affixed within the housing thereof, wherein the housing is configured to be removably affixed to the wearable structure by magnetic attraction including the first magnetic element.

17. The device of claim 16, further including a second magnetic element external to the housing and engageable in a mutual magnetic attraction with the first magnetic element, wherein the housing is configured to be removably affixed to the wearable structure by capturing a portion of the wearable structure between the housing and the second magnetic element when the first and second magnetic elements are engaged in the mutual magnetic attraction.

18. The device of claim 1, wherein the housing includes an elastomeric member extending from the arm portion thereof and receiving channel, a portion of the elastomeric member being receivable in the channel to form at least one loop, and wherein the housing is configured to be removably affixed to the wearable structure by capturing a portion of the wearable structure in the at least one loop.

19. An electronic device, comprising:
a module including:
a display element;
a housing including an arm portion extending along a longitudinal axis of the housing and an elbow portion defining a display end of the housing that supports the display element along a display axis disposed at an angle to the longitudinal axis;
image generating means disposed within the housing and configured for generating an image presentable to a user on the display element; and
an input device affixed to the housing and configured for receiving from the user an input associated with a function, wherein information related to the function is presentable on the display element; and
a wearable structure configured to be worn on the head of a user, the wearable structure being configured to removeably attach with the module at a location along the arm thereof to secure the same to the head of the user with the display element positionable near an eye of the user and the arm portion disposed over a temple of the user.

20. The device of claim 19, wherein:
the wearable structure is a band configured to be worn on the head of a user, the band including an arcuate central portion and a first side portion extending from the central portion, the central portion being configured to contact a portion of the face of a user and the first side portion being configured to contact a portion of the head of the user near an ear thereof; and
the module is removably attached with the wearable structure on one of the side portions of the band.

21. The device of claim 20, wherein the band further includes a second side portion extending from the central portion opposite the first side portion, the second side portion being configured to contact a portion of the head of the user near another ear thereof.

22. The device of claim 20, wherein the central portion of the band further includes a nosepiece depending therefrom, wherein the portion of the face of the user that the central portion is configured to contact is a portion of the nose of the user, and wherein the nosepiece is configured to make such contact.

23. The device of claim 19, wherein:
the wearable structure includes first and second rims with lenses affixed therein and a bridge portion positioned between the first and second rims, the bridge portion being configured to rest on a portion of the nose of the user, the frame further including first and second arms extending away from the rims to respective ends thereof, wherein the first and second arms are configured to be positioned over respective first and second temples of the user with the free ends disposed near first and second ears of the user; and
the module is removably attached with the wearable structure on one of the first and second arms.

24. The device of claim 19, wherein the wearable structure includes at least one electronic element that is configured to removably connect with at least one of the image generating means and the input device.

25. The device of claim 24, wherein the electronic element includes a printed circuit board configured for exchanging data with the at least one of the image generating means and the input device.

26. The device of claim 24, wherein the electronic element includes conductive connections configured for connecting with a battery, and wherein the conductive connections are further configured to provide current from the battery to the at least one of the image generating means and the input device.

27. The device of claim 26, wherein the conductive connections are disposed within a housing configured to receive a battery therein, the housing being attached to the wearable structure and configured to be positioned at least partially behind an ear of the user on a same side of the head of the user as the temple over which the arm portion of the module is disposed.

28. The device of claim 24, wherein the module is removably attached with the wearable structure by releasable connection between a first connection element on the module and a second connection element on the wearable structure, the first and second connection elements being configured for releasable engagement therebetween, and wherein the electronic element is configured to removably connect with the at least one of the image generating means and the input device though the first and second connection elements.

29. A kit, comprising:
a module including:
a display element;
a housing including an arm portion extending along a longitudinal axis of the housing and an elbow portion defining a display end of the housing that supports the display element along a display axis disposed at an angle to the longitudinal axis;
image generating means disposed within the housing and configured for generating an image presentable to a user on the display element; and
an input device affixed to the housing and configured for receiving from the user an input associated with a function, wherein information related to the function is presentable on the display element; and
a first wearable structure configured to be worn on the head of a user;
wherein the wearable structure and the module are configured for releasable engagement therebetween such that the module can be secured to the head of the user by the wearable structure with the display element positionable near an eye of the user and the arm portion positionable over a temple of the user.

30. The kit of claim 29, further including a second wearable structure configured to be worn on the head of the user, the second wearable structure having a different visual appearance from the first wearable structure.
